(19) United States
(12) Patent Application Publication
(10) Pub. No.: US 2026/0320108 A1
(43) Pub. Date: Oct. 15, 2026

(54) SYSTEMS AND METHODS FOR INTEGRATING LARGE LANGUAGE MODELS AND HEURISTIC APPROACHES: A HYBRID FRAMEWORK FOR COMBATING MISINFORMATION

(71) Applicants: Arlen Fan, Phoenix, AZ (US); Fan Lei, Chandler, AZ (US); Steven Corman, Chandler, AZ (US); Ross Maciejewski, Phoenix, AZ (US)

(72) Inventors: Arlen Fan, Phoenix, AZ (US); Fan Lei, Chandler, AZ (US); Steven Corman, Chandler, AZ (US); Ross Maciejewski, Phoenix, AZ (US)

(73) Assignee: Arizona Board of Regents on Behalf of Arizona State University, Tempe, AZ (US)

(21) Appl. No.: 19/318,729

(22) Filed: Sep. 4, 2025

Related U.S. Application Data
(60) Provisional application No. 63/693,068, filed on Sep. 10, 2024.

(51) Int. Cl. G06F 16/45; G06F 16/438; G06F 16/44

(52) U.S. Cl. CPC G06F 16/45; G06F 16/438; G06F 16/44

(57) ABSTRACT

Example implementations of a digital framework and associated operations for combating misinformation using LLMs are disclosed. The framework includes a web browser extension or program that helps filter online news to detect visual and verbal fallacies in journalism. The framework minimizes the amount of misinformation a user sees when accessing online articles, graphs, and other media.

### CROSS REFERENCE TO RELATED APPLICATIONS

This is a non-provisional application that claims benefit to U.S. Provisional Patent Application Ser. No. 63/693,068 filed on Sep. 10, 2024, which is herein incorporated by reference in its entirety.

### FIELD

The present disclosure generally relates to computing technologies including machine learning, browser and User Interface (UI) designs, and the like; and in particular to examples of a hybrid framework for combating misinformation including implementation of large language models with web browsers to filter misinformation in, digital journalism posts and other digital media.

### BACKGROUND

The rapid dissemination of news serves as a critical resource across various domains, from staying up to date with global events to making well-informed decisions in dynamic sectors like the stock market. To enhance accessibility and comprehension of complex datasets, journalists often incorporate large amounts of quantitative information using data visualization. This fusion of data and narrative storytelling, widely recognized as data journalism, has witnessed a surge in popularity across leading platforms such as The Economist, New York Times, and FiveThirtyEight, which regularly feature data visualizations alongside their editorial content.

Data visualizations enhance the storytelling power of articles, making complex narratives more accessible. However, despite their potential for clarity, data visualizations also carry the risk of misleading readers. This can occur unintentionally through poorly crafted visualizations that misrepresent data because of a lack of design expertise, or deliberately, through visualizations designed to exaggerate or skew interpretation of the data. The visualization community has sought to mitigate these issues by developing tools like linters, which aid in rectifying errors during the design phase. However, a more insidious problem lies in the propagation of fake news, which comprises entirely false information that can significantly undermine public trust

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a simplified diagram of an example system for implementing the hybrid framework for combating misinformation described herein.

FIG. 1B is an illustration of an example pipeline of the framework described herein: text and data elements are extracted from news and return annotations about detected fallacies, and readers are able to interact dynamically with the article and the annotations by communicating with the large language model module.

FIG. 2 is an illustration of the 14 fallacies that can be used in the examples of the framework described herein: Fallacies 1-10 are from Musi and Reed, while 11-14 are from Lisnic et al; fallacies are further grouped (far right column) and colored-coded accordingly.

FIG. 3 is an illustration of a two module interface for detecting and annotating fallacies in news: in the fallacy and text-chart linkage annotation module (A), there are three components: (A.1) inline annotations for the original news content, (A.2) content-fallacy linkage, and (A.3) fallacy tags; the multi-layer interventions (B) in the popup panel for each fallacy has three functional parts: (B.1) the explanation of the selected fallacy, (B.2) the three-layer fallacy correction, and (B.3) live chatting with LLM.

FIG. 4 is an illustration of output of case study #1 described herein: the annotations point out a potential False Authority fallacy (A), as the author's views are positioned against scientific consensus without adequate specialization in climate science; additionally, the critique points out Vagueness (B) and Failure to Account for Statistical Nuance (C) in the article, highlighting issues with specificity and the misinterpretation of ice loss trends, respectively.

FIG. 5 is an illustration of fallacies present in case study #2: the Hasty Generalization (A) and Red Herring (B) fallacies are detected and given three annotations, with each level offering more in-depth explanations as to why each excerpt from the article constitutes an occurrence of that fallacy; in (C), the annotation engine detects a Failure to Account for Statistical Nuance, citing that analyses must consider a wider array of factors as to why there is a sharp short-term downtrend in caucus voter turnout.

FIG. 6 is an illustration of fallacies present in case study #3: the Strawman (A) and False Analogy (B) fallacies are detected in the article “The Medical Profession Implodes.”

FIG. 7 is an illustration of a crowdsourced study and expert study pipeline.

FIG. 8 depicts average survey scores on each evaluative dimension described herein.

FIG. 9 is an illustration of survey measures and the results of the crowdsourced study as described herein.

Corresponding reference characters indicate corresponding elements among the view of the drawings. The headings used in the figures do not limit the scope of the claims.

### DETAILED DESCRIPTION

The present disclosure relates to example implementations of a hybrid framework for combatting misinformation in digital media and other digital communications that can include one or more of a large language model (LLM) configured for heuristic approaches in combating misinformation and fallacies online, including digital journalism. In some examples, the inventive concept includes a (client-side) content modification element including a web browser extension/program that helps filter online news to detect visual and verbal fallacies in journalism. The content modification element is configured to minimize the amount of misinformation a user sees when accessing online articles, graphs, and other media.

In some examples, the framework described herein includes three phases or features that use Large Language Models (LLMs) for (1) detection, (2) annotation, and (3) intervention to logical fallacies and connecting charts with article text:
Large Language Model Layer: LLMs parse and analyze entire arguments and logical soundness according to three prompts-one for detecting logical fallacies and one for chart-text linkage. The prompts result in a JSON output that categorizes logical fallacies and chart-text linkages.
Interface Design: two modules, (1) fallacy and text-chart linkage annotations and (2) multi-layer interventions to reduce influence of detected fallacies. Once the program extracts potential fallacies, the interface displays all potential fallacies for users. Users can then filter out specific fallacies according to annotations created by the LLM. If users are not satisfied with the options provided, they can adjust and regenerate the information through the LLM chat.
Fallacy and Text-chart Linkage Annotation: three components—(1) inline annotation, (2) content-fallacy linkage, and (3) fallacy tags. All three methods alert the user to a potential fallacy, and link more information to the annotated fallacy.
Fallacy Intervention: LLM intervenes on fallacy annotations in three ways-(1) an explanation of the selected fallacy, (2) a three-layer fallacy correction, and (3) the live chat with an LLM in relation to the specified fallacy.

Unlike previous methodologies, the inventive concepts herein define an approach that detects potential fallacies within textual or data narratives. The framework combines the analytical strengths of Large Language Models (LLMs) and heuristic approaches to identify and mitigate potential misinformation in data journalism. By integrating these technologies, one aim is to address the dual technical challenges of enhancing the accuracy of data visualizations and ensuring textual integrity in journalistic content. As stated, the hybrid framework can include the implementation of a content modification element such as a web browser extension designed to annotate online data-driven news articles, highlighting potentially deceptive elements by analyzing fallacies and ensuring consistency between the article text and accompanying visual data. Through a series of case studies, a crowdsourced usability experiment, and interviews with subject matter experts, the effectiveness of the approach in aiding readers to critically evaluate news articles is demonstrated, thus contributing to the reduction of misinformation spread and enhancing the credibility of journalistic content. Example contributions include: a novel hybrid analytical framework, the development of a practical tool for real-time news evaluation, and empirical evidence supporting the utility of our approach in improving media literacy and combating misinformation in the digital age.

Other examples are contemplated and described herein.

### 1 Introduction

Researchers have found ways to pinpoint and analyze the spread of misinformation. These models have shown promise in identifying fake news by examining its dissemination patterns on social networks, analyzing the nuances of writing styles, and assessing the credibility of sources. While these models effectively serve as rudimentary fact-checkers, they operate on coarse features of the text and/or information external to the text itself. A more granular approach involves identifying questionable argumentation practices, or fallacies. News websites may use fallacies to construct arguments which, although seemingly valid, are based on flawed reasoning or appeal to common cognitive biases. This issue is compounded by instances where opinion pieces are misrepresented as factual news, a problem that even reputable outlets like the Wall Street Journal have encountered.

This situation highlights a critical limitation of current fact-checking tools: their inability to discern the overarching validity of an argument composed of purportedly factual statements. Addressing this challenge requires the development of more in-depth analytical tools capable of detecting fallacies, an area that remains underexplored. Recent breakthroughs in large language models (LLMs) offer promising capabilities in pattern recognition, real-time analysis, and even educational potential, presenting new techniques for addressing these challenges.

As such, addressing misinformation in journalism necessitates a holistic approach that considers both the textual content of articles and their accompanying data visualizations, and this is the aim of our research. While existing tools have made strides in either improving visualization accuracy through heuristic methods or detecting textual misinformation via AI-based methods, a significant gap remains in integrating these approaches to offer a unified solution. The complexity of interpreting data visualizations, coupled with the subtleties of misinformation, underscores the need for a tool that can both validate the accuracy of visual data and educate the audience on how to critically assess news in a real-world setting. The work described herein aims to bridge this divide, and support readers in critically examining information.

### 2 Other Work

Other works associated with fake news detection, deceptive visualizations, and narrative visualizations are described to illustrate technical drawbacks, issues, and drawbacks that lead to the inventive concept herein.

### 2.1 Fake News Detection

In exploring fake news detection, researchers have primarily focused on methodologies ranging from fact-checking to computational techniques. Zhou and Zafrani's work categorizes fake news as misinformation in the guise of authentic news, highlighting the challenges in discerning truth from falsehood. Traditional detection methods emphasize fact-checking against a database of verified information, a process that, while effective, struggles with scalability and demands considerable resources. To enhance detection capabilities, researchers have integrated diverse features, including author profiles, social media analytics, and the dynamics of news propagation. These advancements underscore the complexity of misinformation, which not only manifests through factual inaccuracies but also through the manipulation of logical structures within seemingly valid narratives. RumorLens uses a combination of NLP, propagation networks, and features about the author to analyze false information on social media. However, these methods, although expanding the range of detection, still face issues related to accessibility and computational requirements, particularly for the general public.

In order to address the problem of high computational cost, researchers have built lightweight systems to combat misinformation. Nguyen et al. propose a UI system that leverages automated algorithms for information retrieval and machine learning, along with interactive elements that allow users to apply their own critical thinking and knowledge to the verification process. Their findings suggest that such hybrid approaches can improve the accuracy of fact-checking by involving users in the evaluation process, thus addressing some of the scalability issues inherent in manual fact-checking methods while also mitigating the risks of over-reliance on automated systems. WikiCheck is another tool that can perform fact-checking. It employs a two-level model architecture: the first level uses the Wikipedia Search API to find relevant articles based on the input claim, while the second level applies a Natural Language Inference (NLI) model to assess the claim's veracity against the retrieved evidence. It is also capable of running on low-memory CPU instances, ensuring computational efficiency for real-time use.

The subject inventive concept extends beyond traditional fact-checking and fake news detection by introducing a method that analyzes not just the factual accuracy but also the logical coherence of news content. It is recognized that fallacies can mask misinformation within factually accurate statements, thus the disclosure aims to uncover these potentially deceptive tactics. Doing so accommodates a more comprehensive tool for news analysis.

### 2.2 Deceptive Visualizations

Expanding the investigation of misinformation beyond text to encompass the visual dimension, our work also explores how deceptive visualizations contribute to the spread of misinformation in journalism. Deceptive visualizations, as defined by Pandey et al., are “a graphical depiction of information, designed with or without an intent to deceive, that may create a belief about the message and/or its components, which varies from the actual message.” Scholars have studied and quantified how certain chart construction techniques influence a reader's perception of the data. For example, Pandey et al. show how truncating y-axes exaggerates the effect size on the reader. Munzner notes that introducing unnecessary 3D elements to graphs leads to more inaccurate readings and comparisons. Lo et al.'s taxonomy further brings light to the mechanisms by which visualizations deceive, ranging from exploiting graphical conventions to the unintended consequences of design choices, aligning closely with our study's focus on the multifaceted nature of misinformation. Their work divides deceptive visualizations into four major categories: informal fallacies in visualizations, exploiting conventions and data literacy, deceptive tricks in uncommon charts, and understanding the designers' dilemma (which is despite the author's best efforts to make an honest graph, the chart still appears misleading). Most recently, Lisnic et al. (Maxim Lisnic, Cole Polychronis, Alexander Lex, and Marina Kogan. 2023. Misleading beyond visual tricks: How people actually lie with charts. In Proceedings of the 2023 CHI Conference on Human Factors in Computing Systems. 1-21) propose a taxonomy focusing on the attributes of visual misinformation on social media, illustrating this through examples of visualization-supported misinformation. They introduce a theoretical framework to understand how data visualizations reinforce misinformation arguments through inductive reasoning. They offer design recommendations to safeguard charts against misinterpretation, thereby contributing a novel perspective to the discourse on misleading visual representations.

The inventive disclosure herein leverages aspects of the Lisnic et al. framework as a mechanism for identifying potential fallacies in data driven journalism.

### 2.3 Chart-Text Linking

The integration of text and charts for enhancing data-driven storytelling has seen advancements lately, with Beck and Weiskopf pioneering effort to link visualization and text through outlined potential interaction techniques. This foundational concept was further actualized by Latif et al., who developed a framework enabling the creation of interactive webpages from text markup, datasets, and configuration files. Their work facilitated visual highlights, details on demand, and brushing-and-linking, although requiring manual declarative programming. Pinheiro and Poco introduce a method for linking charts to short texts which relies on matching chart elements to text based on unique words and numerical values.

The inventive concept herein builds upon previous work by introducing a fully automatic method, eliminating the need for complex training stages and manual programming.

Chart-text linking has been widely explored in authoring tools such as CrossData by Chen and Xia. Their work shows the importance of maintaining persistent connections between text and data to ease the authoring of data documents. It functions using a connector engine, which dynamically establishes text-data links, enhancing the data narrative writing experience. Similarly, Sultanum et al.'s VizFlow emphasizes the utility of text-chart linking in writing data-driven articles, particularly leveraging such links to support various storytelling formats like scrollytelling. Latif et al.'s Kori introduce a mixed-initiative approach that automates the suggestion of references and accommodates manual input, which also improves the integration of text and data visualization. DataTales is yet another system that explores the application of LLMs in the authoring of data-driven articles by providing more control over narrative style and enabling micro-tasks for co-writing.

In the inventive examples herein, a transition is made from examining authoring tools to analyzing the construction and reception of published data-driven narratives, aiming to assess their impact and effectiveness. Through scrutinizing the integration of text and data visualizations in these narratives, it is sought to enhance understanding, engagement, and critical thinking among readers.

### 3 Expandable Framework for Detecting and Annotating Fallacies

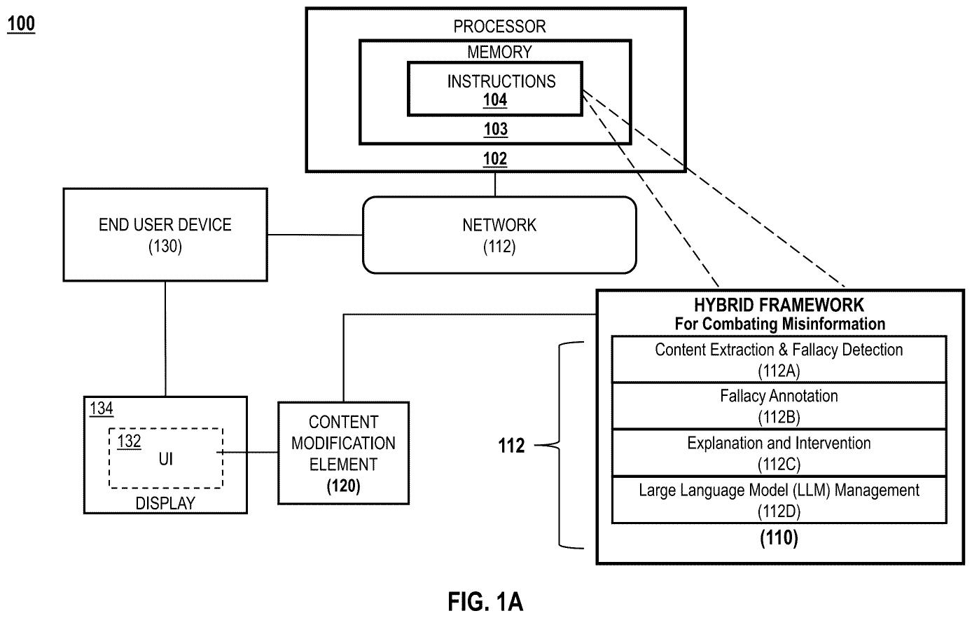

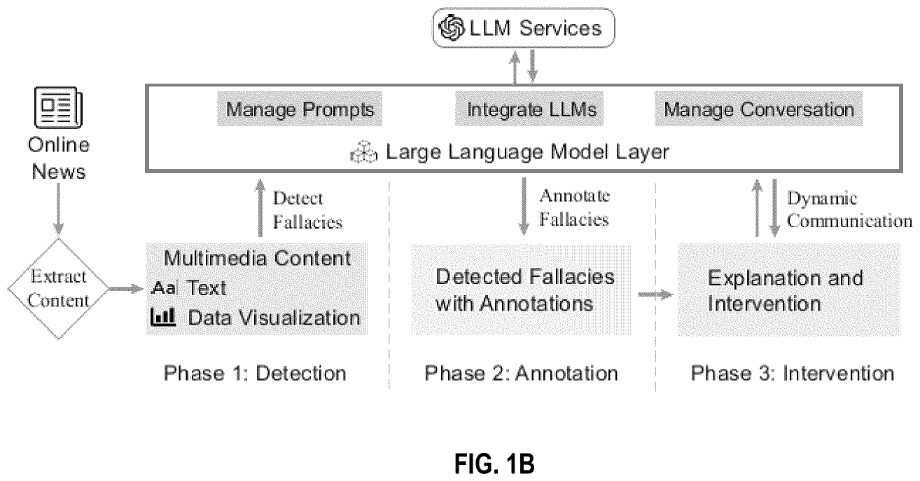

Referring to FIG. 1A, examples of a hybrid framework are described as a technical solution to the aforementioned. In the non-limiting example shown, the system 100 includes at least one processor 102, and at least one of a memory 103 or storage device 103 storing instructions 104 accessible by the processor 102. In general, the processor 102 is configured, via the instructions 104, to implement a hybrid framework 110 for combatting misinformation via a network 112 or otherwise. The hybrid framework 110 includes components 112 that combine the analytical strengths of Large Language Models (LLMs) and heuristic approaches to identify and mitigate potential misinformation in data journalism. As indicated, aspects of the hybrid framework 110 can be implemented as a content modification element 120 executed by an end user device 130 that, e.g., annotates online news for detecting potential visual and verbal deception.

The hybrid framework 110 approach transcends traditional fact-checking by incorporating an analysis of logical and reasoning errors, as well as ensuring alignment between article text and visualizations, significantly impacting the message credibility of the presented information. This dual analysis is important for providing readers with a complete understanding of the data narrative. This is a key aspect of media literacy, a skill whose importance is increasing with the continuing growth of misinformation. This end-to-end solution aims to protect and shield the public from consuming fake and predatory news sources. Through case studies and a usability experiment, the effectiveness of the hybrid framework 110 is demonstrated in flagging potentially deceptive information.

As a simple non-limiting example, the end user device 130 can access digital media via a user interface (UI) 132 executed via a display 134 associated with the device 130, and the end user device 130 can implement the content modification element 120 to, e.g., annotate online data-driven news articles, highlighting potentially deceptive elements by analyzing fallacies and ensuring consistency between the article text and accompanying visual data. In some examples, the UI 132 includes a web browser, and the content modification element 120 can include a browser extension as demonstrated herein. As indicated, components 112 or services of the hybrid framework 110 that power the content modification element 120 can include by non-limiting examples content extraction and fallacy detection 112A, fallacy annotation 112B, explanation and intervention 112C, and large language model (LLM) management 112D.

The aforementioned instructions 104 can be implemented as code and/or machine-executable instructions executable by the processor 102 that may represent one or more of a procedure, a function, a subprogram, a program, a routine, a subroutine, a module, service, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

Referring to FIG. 1B, examples implementations of the hybrid framework 110 can be designed to annotate and/or highlight parts in articles that may contain potential misinformation and explain the potentially misleading items are introduced. The technique stands apart from prior research works and existing platforms such as Snopes or PolitiFact, which primarily serve as fact-checking resources. The approach can include three phases (FIG. 1B) that use LLMs for dynamically providing 1) detection, 2) annotation, and 3) intervention to logical fallacies and connecting charts with article text, enabling a more thorough examination of data-driven narratives. After introducing the design objectives, methods are explained for extracting multimedia content from online news sources. Next, the expandable classification system for logical fallacies are described. Finally, an example design of the Large Language Model Layer is introduced which handles the interface communication.

### 3.1 Design Objectives for Measurable Evaluation

To ensure the practicality and effectiveness of the proposed framework in combating misinformation, five specific design objectives were identified through collaboration with a communications expert. These objectives guide the development process (Section 3.23.5 and 4) and provide measurable criteria for evaluating (Section 6) the framework's performance. They are as follows:
DO1: Identifying potential fallacies in online news automatically. To combat misinformation, it is important to identify embedded fallacies without relying heavily on manual efforts or specialized domain knowledge. Traditional methods require domain experts to manually weigh in with their knowledge, which makes these efforts expensive. The subject tool automates the process, leveraging the capabilities of language models to identify fallacies.
DO2: Annotating detected fallacies (and other relevant information) dynamically. Once a potential fallacy is identified, it is important to communicate this information properly to the reader. Therefore, the tool will dynamically annotate or mark sentences within an article that correspond to a detected fallacy. This feature visually guides readers through the content, which in turn enables a more critical engagement with the material. Additionally, issues are addressed related to the coherence between charts and text, ensuring that any discrepancies or misleading representations are clearly indicated.
DO3: Providing interventions to effectively reduce the fallacy influence. Beyond identifying (DO1) and annotating (DO2) fallacies, the tool can offer interventions designed to mitigate the influence of these fallacies on the reader. These interventions may include providing clarifications, offering additional context, or presenting counterarguments to challenge misleading claims. Guided by Cook et al.'s research on misinformation correction, the interventions can be designed in such a way to minimize the effect of these fallacies. These interventions are tiered and offer progressive clarification and contextual grounding to challenge potentially misleading arguments. Detailed elaboration of these intervention levels will be explained in Section 4.
DO4: Adapting to varying fallacy types. Given the variety of fallacies that can be employed to distort information, the tool can be flexible to adapt to a wide range of identified fallacies. The classification of these fallacies can vary: Musi and Reed outline 10 distinct categories of fallacies, whereas Lisnic et al. have identified 7 specific reasoning errors in the context of data visualization. In the domain of argument appraisal, Tindale's work lists an extensive 47 fallacies. The initial framework will incorporate the fallacies as classified by Musi and Reed and Lisnic et al., but it is engineered to be extensible, allowing for the integration of additional fallacies.
DO5: Adapting to real-world scenarios. The pressing need for effective tools in discerning accurate information has never been more critical, as highlighted by Lazer et al. in their comprehensive examination of the fake news phenomenon and its widespread implications on society. In an era characterized by the rapid dissemination of information and the proliferation of misinformation, the tool should serve to stand against fake news, offering a robust mechanism for the real-time analysis of articles. By aligning the development process with the insights and call to action provided by Lazer et al., the importance of providing novel and robust tool aimed at fighting misinformation in new ways is reiterated.

### 3.2 Extracting Multimedia Content from Online Data-driven News

Misinformation often spreads through a combination of text and data visualizations in online data-driven news. To effectively detect the potential fallacies from online hybrid news sources (DO1), it is desired to recognize and extract the main contents and reformat them as input to the language modules (e.g., LLMs).

Extracting Text Content. To extract the text content that adapts to the varying formats in news websites automatically in a real-time (DO5), inspired by Lin and Ho's work (Shian-Hua Lin and Jan-Ming Ho. 2002. Discovering informative content blocks from Web documents. In Proceedings of the Eighth ACM SIGKDD International Conference on Knowledge Discovery and Data Mining (Edmonton, Alberta, Canada) (KDD '02). Association for Computing Machinery, New York, NY, USA, 588-593. https://doi.org/10.1145/775047.775134), the subject fully automatic approach is built upon the ParEx (Howard J. Carey and Milos Manic. 2016. HTML web content extraction using paragraph tags. In 2016 IEEE 25th International Symposium on Industrial Electronics (ISIE). 1099-1105. https://doi.org/10.1109/ISIE.2016.7745047) to collect the text content within an article on a website while filtering out as much irrelevant information as possible.

Extracting Data and Metadata from Data Visualizations. Fan et al. (XXX) introduced a tool that can recover the data and the meta-data of the layout of the visualization. They do so by extracting the data using WebPlotDigitizer (F Marin, A Rohatgi, and S Charlot. 2017. WebPlotDigitizer, a polyvalent and free software to extract spectra from old astronomical publications: application to ultraviolet spectropolarimetry. arXiv preprint arXiv:1708.02025 (2017).) and the specifications through a machine learning method proposed by Poco and Heer (Jorge Poco and Jeffrey Heer. 2017. Reverse-engineering visualizations: Recovering visual encodings from chart images. In Computer graphics forum, Vol. 36. Wiley Online Library, 353-363.). In the examples described herein, these two same methods (incorporated herein by reference in their entireties) can be used to extract the data and the specifications. The first phase involves retrieving data from the line chart, using WebPlotDigitizer for data extraction. This application utilizes affine transformations for converting chart positions into data points, based on a human-defined calibration of the axes. The next step is to extract the specifications or the non-data elements of a chart such as axes labels and titles. The process, developed by Poco and Heer, begins with the identification of text within an image, employing computer vision techniques to detect patterns resembling text characters and enclosing them in bounding boxes based on their coordinates and dimensions. Optical character recognition (OCR) interprets these pixels as text, converting the visual text into a digital string. The recognized text is then classified according to its role in the chart-such as data labels, axis titles, or legend entries-using machine learning models trained to understand the spatial and semantic context of text elements in charts. This process results in a structured representation of the chart's text content, enabling applications like data extraction, chart comparison, and automated recreation. The output includes detailed attributes for each text element, such as coordinates, dimensions, textual content, and classified role (e.g., y-axis label), which can be used to describe a chart to an LLM.

### 3.3 Classification for Logical Fallacies

In developing an expandable framework for detecting logical fallacies as noted in DO1, the structured approach by Musi and Reed (Elena Musi and Chris Reed. 2022. From fallacies to semi-fake news: Improving the identification of misinformation triggers across digital media. Discourse & Society 33, 3 (2022), 349-370) is examined. Their methodology is rooted in qualitative analysis, focusing on the identification of logical fallacies within the content of fake news articles. The authors create a taxonomy with ten distinct logical fallacies. Their approach provides a baseline from which we can identify and understand the common tactics used in the construction of deceptive arguments.

Building upon this foundation, the taxonomy proposed by Lisnic et al. is then explored, which is characterized by its use of open coding. This method introduces a level of flexibility and adaptability that is particularly suited to the dynamic and varied nature of social media discourse. While there is some overlap with the fallacies identified by Musi and Reed, Lisnic et al.'s approach enables to merge these shared fallacies and incorporate additional ones into the subject expanded framework.

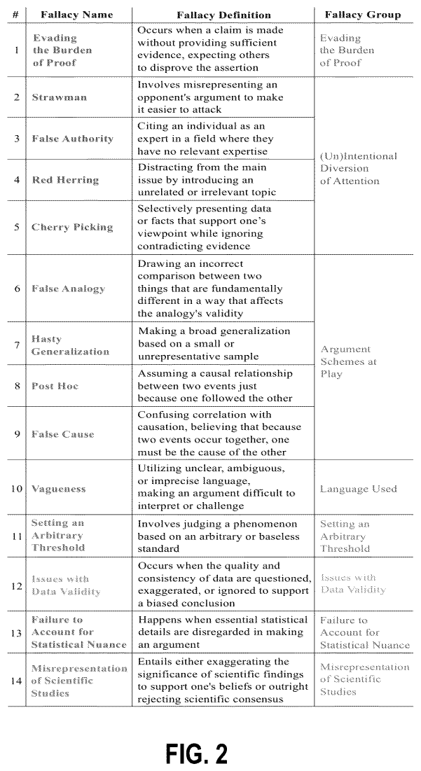

The first ten fallacies from by Musi and Reed are shown in FIG. 2. Subsequently, the four additional fallacies identified by Lisnic et al. are incorporated, while merging three fallacies from Lisnic et al. that significantly overlapped with Musi and Reed's taxonomy—specifically, cherry-picking, causal inference (post hoc), and vagueness. While the fallacies chosen to include are not exhaustive, they represent a strategic selection from the work of Musi and Reed and the expansion by Lisnic et al., chosen for their significant impact from a UI-engineering and data visualization perspective. Although Tindale's overview of fallacies provides a more extensive landscape, practical constraints and the current capabilities of LLMs limit initial scope. However, the inventive framework is designed to be expandable, allowing for future inclusion of additional fallacies as advancements in LLMs enhance the ability to interpret and analyze complex argumentative structures. This expandable approach ensures that the subject system can evolve and accommodate a broader range of fallacies in the future, aligning with design objective DO4.

### 3.4 Large Language Model Layer

The subject framework leverages the power of LLMs to combat the fallacies in online news articles. The large language model layer serves as the middleware that handles the communication between the frontend interface and the LLMs. This layer supports three tasks as shown in FIG. 1: 1) the LLM prompts management, 2) the flexible integration of LLMs, and 3) the conversation management between the reader and the LLM.

Prompt Management. Within the subject prompt engine, one can deploy two tailored GPT prompts specifically engineered to address the challenges of detecting logical fallacies and effectively linking chart data with article text. This approach leverages LLMs to parse and analyze entire arguments and logical soundness, distinguishing our methodology from traditional fact-checking mechanisms.

Detecting Logical Fallacies. The first prompt is designed to identify an array of logical fallacies within the article text. Drawing upon the expanded fallacy taxonomy that synthesizes the classifications by Musi and Reed and additional categories identified by Lisnic et al., this prompt instructs the LLM to scan the article for indicative signs of each listed fallacy. The process entails:
Presenting the LLM with definitions and examples of each fallacy, thereby equipping the model with the necessary context for accurate identification.
Requesting the LLM to output instances where these fallacies might be present, specifying the exact location (i.e., sentence numbers) and providing a rationale based on the input definitions.
For articles containing data visualizations, the prompt also incorporates the possibility of fallacies related to data interpretation, instructing the LLM to consider the provided specifications and data of the chart in its analysis.

Chart-Text Linkage. The second prompt focuses on establishing connections between the article text and its accompanying data visualizations. This involves:
Providing the LLM with details or data necessary to comprehend the chart, including a CSV file format that contains chart data.
Instructing the LLM to match sentences within the article that reference or interpret the chart's data, thereby identifying direct linkages between text and visualization.
The LLM is prompted to output these linkages in a JSON format, detailing the sentences and corresponding bounding boxes on the chart that relate to the text's claims or interpretations.

This precise mapping between narrative and data reveals instances where visual information might be misrepresented or misinterpreted in the narrative, showing discrepancies in the article's discussion of the presented data.

Output and JSON Structure. The culmination of these prompts results in a structured JSON output that categorizes identified logical fallacies and charts-text linkages. This output includes:
An array of logical fallacies detected, with annotations providing a rationale for each identified instance.
Sentence ranges indicating where each fallacy occurs within the article, allowing for direct reference.
For sentences involving chart-text linkage, a detailed enumeration of sentences and their corresponding areas within the chart are used.

This output structure enables the analysis of both the logical coherence of the narrative and the accuracy of its data representations. Through the application of these specialized prompts, one can go beyond fact-checking by supporting reasoning about text and data, providing a novel solution to the challenges of misinformation in data-driven journalism. It should be noted that the output can include other similar structures/systems outputs including XML, Protocol Buffers, YAML, Avro, or a similar proprietary serialization.

Conversation Management. The subject framework provides interventions to reduce the potential fallacy influence on readers (DO3) including live chats to the LLM for consulting more information about the detected fallacy. The LLM layer manages the conversation between a reader and the model by handling the chat API and memorizing the conversation history.

### 4 Interface Design

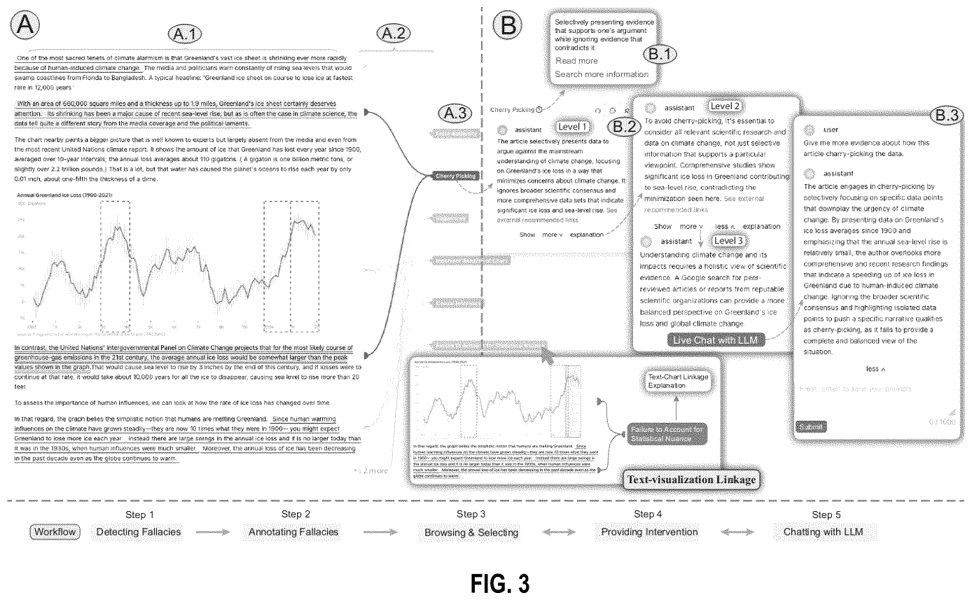

The framework interface contains two modules: 1) fallacy and text-chart linkage annotations (DO2, FIG. 3(A)) and 2) multi-layer interventions to reduce the influence of the detected fallacies (DO3, FIG. 3(B)). To enable readers to recognize misinformation more effectively, the core concept of the interface design lies in building the dynamic interactive linkage visually between a set of fallacy-fixing interventions and the target text or visualization blocks that have been identified as containing potential fallacies. During the development lifecycle, a communications expert was leveraged to verify the design of every functional component.

Reader's Workflow. The framework supports five operations in the reader's workflow, FIG. 3 (Workflow). After extracting the news content and detecting potential fallacies (step 1), the interface displays an overview of all the detected fallacies with visual marks on the related text and chart blocks (step 2). The interface allows readers to browse the overall fallacy distribution in the article and filter the fallacy they are interested in by clicking an annotation (step 3). The interface then provides interactive information generated by the LLM as interventions to potentially mitigate the influence of the selected fallacy, (step 4). If readers are not satisfied with the LLM-generated information, they can regenerate it or adjust the information through the LLM chat (step 5).

### 4.1 Fallacy and Text-chart Linkage Annotation

Establishing visual cues between the article content and the potential fallacies is crucial for critical reading and can potentially reduce the spread of misinformation. In this module, we use interactive visual components and a context-preserving design to link each potential fallacy to the corresponding text or chart block in the news article (FIG. 3(A)). To make each fallacy type distinguishable from others, we use an 8-class qualitative color scheme that assigns different colors to the fallacies belonging to different categories as presented in FIG. 2.

The module can include three components: 1) the inline annotation (FIG. 3(A1)) on the original news text and chart content, 2) the content-fallacy linkage (FIG. 3(A2)), and 3) the fallacy tags (FIG. 3(A3)). In each component, for the sentences accompanied by data visualizations, we establish additional visual or verbal linkages between them if there is a fallacy detected.

Inline Annotation. The fallacy detection result from the model contains sentence ranges corresponding to the content blocks where each fallacy occurs. Colored underlines can be used to interactively mark the sentences that are considered to have fallacies (FIG. 3(A1)). When a reader hovers or clicks on a sentence with such inline annotation, the sentence background can be highlighted in the same color as the fallacy link to it. Meanwhile, the whole linkage from the selected sentence to its fallacy tag can be highlighted synchronously to let the reader keep focusing on the selected content and its fallacy.

Content-fallacy Linkage. Multiple sentences may share the same fallacy type but in different paragraphs of the article. To effectively link each fallacy tag and its corresponding retraction treatments to the related context block(s), we can establish dynamic visual links based using cubic Bezier curves (FIG. 3(A2)). To minimize the occlusion of the selected content-fallacy linkage and make the target linkage stand out from surrounding information, we highlight the clicked linkage by adjusting the line opacity. The color of each link remains the same as the fallacy color. The lines that link the content blocks and the fallacy tags are dynamically updated with the web page scrolling to keep an intuitive linkage.

Fallacy Tags. The right-side terminal of the content-fallacy linkage is the fallacy tags (FIG. 3(A3)) which display the detected fallacy names. Readers can click on one fallacy tag, and the whole linkage of this fallacy will be highlighted to make the corresponding content block(s) visually salient. A popup panel containing the hierarchical fallacy intervention information can be triggered by clicking.

Text-visualization Linkage. Our framework also detects the fallacies in the connection between the article text and its related data visualizations. For the sentences containing fallacies that are linked to the visualization chart, we add visual bounding boxes with dashed borders to the corresponding areas on a chart image as FIG. 3 (Text-visualization Linkage) shows. The interface highlights the bounding box and corresponding sentences synchronously when hovering or clicking one of them. Meanwhile, there is a line connecting each bounding box and the related fallacy tag as part of the content fallacy linkage.

### 4.2 Fallacy Intervention

Guided by the misinformation correction methods from the communication domain, the framework can provide a set of interactive intervention approaches in the popup panel for each fallacy annotation (FIG. 3(B)). Inspired by the dynamic error-explanation linkage design from Lei et al.'s linter system incorporated by reference herein (Fan Lei, Arlen Fan, Alan M. MacEachren, and Ross Maciejewski. 2024. GeoLinter: A Linting Framework for Choropleth Maps. IEEE Transactions on Visualization and Computer Graphics 30, 2 (2024), 1592-1607. https://doi.org/10.1109/TVCG. 2023.3322372), we support instant explanations and correction information beside each detected fallacy like a linter framework automatically with the help of LLM. The intervention contains three functional parts: 1) an explanation of the selected fallacy (FIG. 3(B1)), 2) a three-layer fallacy correction (FIG. 3(B2)), and 3) the live chat with LLM in the context of the selected fallacy (FIG. 3(B3)). Readers can regenerate the fallacy explanations and corrections by clicking the “refresh button” (Ω).

Fallacy Explanation. The explanation for a selected fallacy gives readers a better understanding and extra contextual information that facilitates their engagement with the follow-on intervention information. By hovering on the “question mark” (\textcircled{?}) beside the fallacy name, a popup window displays the brief textual explanations. Readers can click “read more . . . ” to check the fallacy definition on Wikipedia. This panel also connects to the search engine API. Readers can search for more information about the fallacy by clicking the “Search more information” link. For a fallacy related to the misinterpretation between the data visualization and text content in an article, we provide an additional explanation for justifying why the fallacy is identified in the selected chart-text linkage.

Hierarchical Misinformation Correction Strategy. Our approach employs a hierarchical strategy to correct misinformation, inspired by the method outlined by Cook et al. (John Cook, Ullrich Ecker, and Stephan Lewandowsky. 2015. Misinformation and how to correct it. Emerging trends in the social and behavioral sciences: An interdisciplinary, searchable, and linkable resource (2015), 1-17). This strategy is divided into three distinct levels of intervention, designed to provide a complete response to detected fallacies.

The first level (FIG. 3 (Level 1)), Basic Clarification aims to quickly address the misinformation by providing a straightforward explanation of why the information is misleading. This immediate correction is a necessary first step for correcting basic misconceptions and preventing the spread of misinformation. The second level (FIG. 3 (Level 2)), In-Depth Correction with Evidence, goes beyond clarification by offering additional evidence. This level educates readers and encourages a more critical approach to evaluating information. The third and final level, Preemptive Information and Contextual Education (FIG. 3 (Level 3)), anticipates common forms of misinformation and addresses them before the user encounters them. A proactive approach enables readers to set up a cognitive guard before this misinformation occurs as it is hard for any information to be retracted (factual or incorrect) and thus, if a preemptive warning is set up, this problem may be mitigated.

To facilitate reader engagement without overwhelming them, our interface allows readers to control the depth of information presented. By selecting “more” (more ∨) or “less,” (less ∧) in the interface, readers can navigate through the layers of correction, from basic clarification to in-depth analysis and preemptive education. When applicable, layers contain an outbound link for further exploration on search engines like Google and Bing, supporting lateral reading and cross-referencing of sources for additional information.

Chatting with the LLM. The LLM-generated fallacy explanations may not be able to cover all the necessary parts for a reader to fully understand the detected fallacy issues. There should be a mechanism for readers to flexibly consult with the LLM and get a deeper understanding of the fallacy based on their needs. Our framework provides a live chat function for readers to communicate with the LLM. Readers can type their message and send it to the LLM in the text area at the bottom of the panel (FIG. 3(B3)). The LLM will reply to the reader in real-time right after the reader's message. They can also start chatting by clicking the “chat icon” (θ) on the panel's toolbar. In order to enhance usability and reduce the learning loads in a reader's fallacy-correction workflow, the content layout for fallacy explanations is similar to the one used in popular chatting apps.

### 4.3 Implementation

The framework interface is implemented in the form of a web browser extension which provides an immediate and straightforward fallacy detection and correction experience, and meanwhile, maximizes its ability to adapt to a wide range of online news websites. To facilitate the future expansion and maintenance of the framework, we use React to implement a modularized interface. The interactive content-fallacy linkages and related animations are drawn by D3.js. We use asynchronous APIs to connect to the back-end services to avoid communication stuck in the workflow. A Flask-based back-end server contains the large language model layer functions for communication with the LLM and provides support to multiple LLMs.

### 5. Case Studies

To demonstrate the practical application and effectiveness of our framework, we present three case studies focused on real-world news stories. Upon simply loading the articles into our framework, along with any accompanying images and charts, the system autonomously detects a wide array of logical fallacies without the need for any manual inputs. This approach highlights how our tool achieves the design objective DO5: Adapting to real-world scenarios.

### Case Study 1: Greenland's Melting Ice is No Cause for Climate-Change Panic

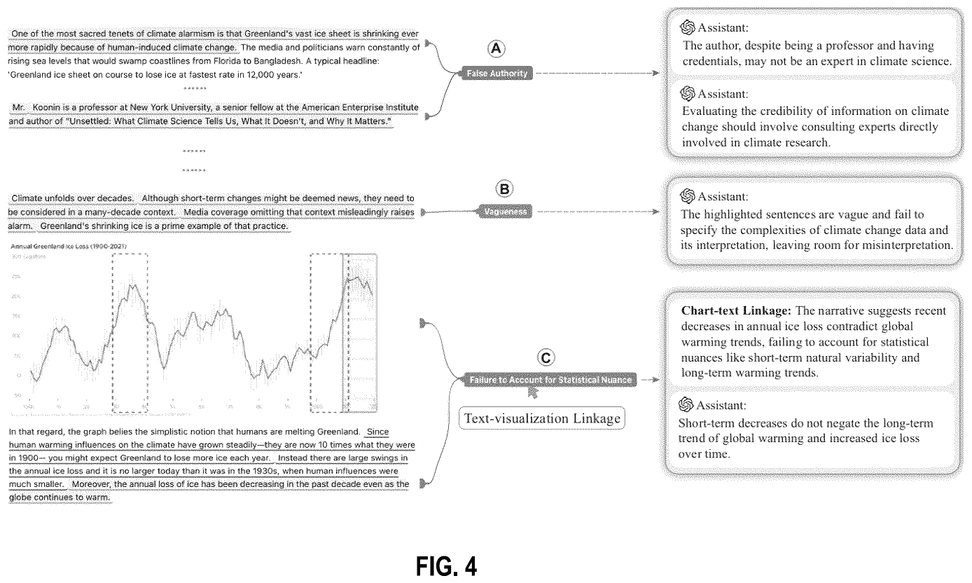

The article “Greenland's Melting Ice Is No Cause for Climate-Change Panic,” authored by Steven E. Koonin, presents an opinion that challenges the prevalent narrative on the impact of climate change on Greenland's ice sheet (FIGS. 3 and 4). Published on Feb. 17, 2022, in the Opinion section, Koonin argues against the alarmism surrounding the melting of Greenland's ice, suggesting that the situation is not as dire as portrayed in the current discourse. He highlights that despite ongoing global warming, the annual loss of ice from Greenland has seen periods of decrease over the past decade, contrary to expectations based on human-induced climate change. According to our annotation backend, the piece employs a range of fallacies to support its argument (FIG. 3(A)). Beginning with Cherry-Picking, Koonin selectively presents data to argue against the mainstream understanding of climate change, focusing on Greenland's ice loss in a way that minimizes concerns. This approach ignores broader scientific consensus and data that suggest significant ice loss and sea-level rise. The annotation gives links to external sources that offer evidence contradicting the claims made in the article, advocating for a more balanced and informed perspective on the issue (FIG. 3(B)).

The critique also highlights the issue of False Authority (FIG. 4(A)). The article places undue emphasis on Koonin's perspective to challenge the broad scientific consensus on climate change, despite potential gaps in his direct specialization in climate science. Additionally, the analysis addresses the Vagueness present in Koonin's argumentation (FIG. 4(B)). He writes “Media coverage omitting that context misleadingly raises alarm. Greenland's shrinking ice is a prime example of that practice” which lacks the necessary specificity, making it challenging to grasp the scientific consensus on the impacts of climate change, particularly concerning Greenland's ice melt. Such vagueness leaves readers unclear on the argument's specifics, reducing the discussion to an unfocused critique. Furthermore, the article's interpretation of data regarding Greenland's ice loss trends over time might be misleading, suggesting recent decreases in annual ice loss contradict global warming trends without accounting for statistical nuances (Failure to Account for Statistical Nuance) like short-term natural variability and long-term warming trends. Correcting this misconception emphasizes that short-term decreases do not negate the long-term trend of global warming and increased ice loss over time (FIG. 4(C)). This case study highlights the importance of considering both sides and looking out for faulty rhetoric when reading opinion articles. It highlights the necessity of considering all relevant scientific research and data, consulting credible sources, and properly using data and visualizations.

### Case Study 2: How the Iowa Caucuses are Changing in 2024

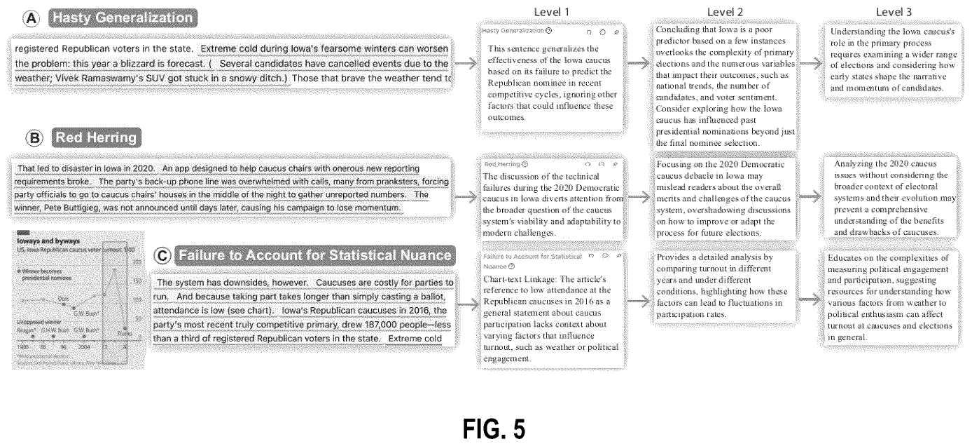

The article “How the Iowa Caucuses Are Changing in 2024,” published in the Economist, discusses adjustments within the political tradition of caucusing in Iowa, focusing on the shift by the Democrats from an in-person to a mail-in ballot system (FIG. 5). This marks a significant departure from a tradition that dates back to the 1970s, highlighting evolving strategies within American political primaries. The Republicans, however, will follow traditional caucusing in only six states, underscoring a divergence in approach between the two major political parties. The analysis identifies several logical fallacies, including Hasty Generalization, Red Herring, and Vagueness.

First, the Hasty Generalization fallacy (FIG. 5(A)) is evident in the article's critique of caucuses based on their cost and low attendance, without fully considering the benefits they offer in terms of voter participation. The excerpt from the original article, “Extreme cold during Iowa's fearsome winters can worsen the problem: this year a blizzard is forecast,” exemplifies how a single factor is exaggerated to undermine the caucus system without acknowledging its broader value to Iowa's political culture. The critique of caucuses for being costly and poorly attended, as highlighted by an example of extreme weather, fails to account for the full picture of what caucuses contribute, thereby making this a Hasty Generalization.

The Red Herring fallacy (FIG. 5(B)) in the article diverts attention from the core issues surrounding the future and effectiveness of the caucus system by overly focusing on the technical hardships of the 2020 caucus. Specifically, the article writes about the malfunctioning app and the overwhelmed backup phone system, which led to significant delays in announcing the Democratic caucus results. By concentrating on this isolated incident, the narrative shifts in a way that contributes to the perception of caucuses as disorganized, even though these technical issues may not be directly relevant to the overall effectiveness of the caucus process itself. This diversion acts as a Red Herring, misleadingly suggesting that one technical difficulty is indicative of the caucus system's fundamental flaws.

The analysis also points out a Failure to Account for Statistical Nuance fallacy in the chart data (FIG. 5(C)). The author writes “The system has downsides, however. Caucuses are costly for parties to run. And because taking part takes longer than simply casting a ballot, attendance is low (see chart).” This assertion is linked to the noticeable decline in Republican caucus voter turnout between the 2016 and 2020 election years. Our critique, however, highlights that this portrayal of low attendance generalizes the situation without adequately considering the diverse elements that can affect turnout, such as inclement weather or varying degrees of political mobilization among voters. By not explaining these factors, the article simplistically attributes the decline in participation to the caucus format's inherent disadvantages, and not considering other valid reasons for changes in voter turnout. This case study further exemplifies the utility of critical analysis in identifying fallacies and responsibly interpreting data.

### Case Study 3: The Medical Profession Implodes

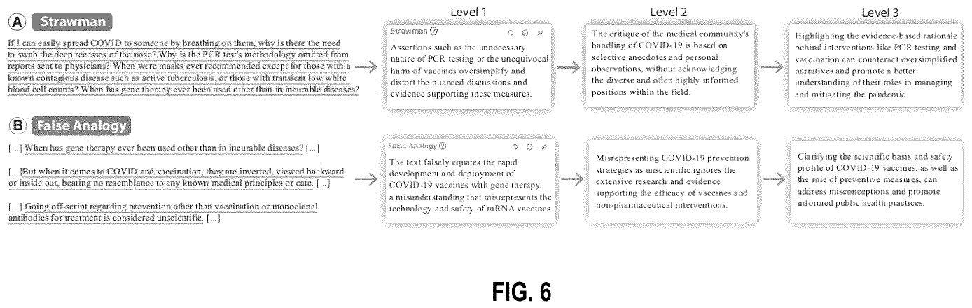

The article “The Medical Profession Implodes,” authored by Steve Karp, M.D., and published on Dec. 13, 2021, in the American Thinker, offers a critical perspective on the medical profession's response to the COVID-19 pandemic (FIG. 6). Karp suggests that the medical field has abandoned scientific principles in favor of adhering to government mandates and public health policies, which he views as overreaching and not grounded in sound science. He criticizes the rapid adoption of COVID-19 vaccines, likening their development to gene therapy, and questions the efficacy and safety of pandemic-related health measures such as PCR testing, masking, and social distancing. Our analysis identifies several logical fallacies within Karp's argument, notably Strawman and False Analogy, which undermine the credibility of his critique.

Strawman is evident in Karp's portrayal of the medical community's adherence to COVID-19 guidelines as complete mind control by the government (FIG. 6(A)). This misrepresents and oversimplifies the debates within the medical and scientific communities about the best approaches to managing the pandemic. By attacking this oversimplified argument, Karp fails to engage with the actual reasons and evidence that have guided public health recommendations and policies, thus making this argument a strawman.

The False Analogy fallacy is also present in Karp's comparison of the development and deployment of COVID-19 vaccines to gene therapy (FIG. 6(B)). This analogy misleads by equating two distinct scientific processes and therapeutic approaches, causing confusion about the nature of mRNA vaccines. Such a comparison ignores the clinical research that mRNA vaccines underwent before their authorization for emergency use. This oversight diminishes the article's argument by conflating unrelated concepts to question the validity of COVID-19 vaccines.

### 6 Evaluation

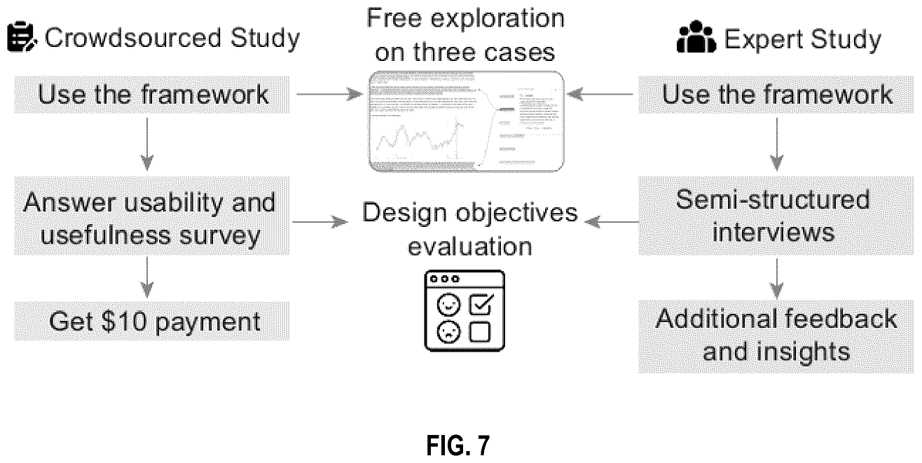

Evaluation is divided into two parts (see FIG. 7 for the study sequence). The initial phase involves crowdsourcing, focusing on gathering feedback pertinent to our design objectives. Following this, we engage in expert interviews to obtain more detailed insights as well as future directions of research.

### 6. 1 Quantitative Analysis

Participants for our study were recruited via Prolific.co, with eligibility criteria including U.S. residency, desktop computer usage, and a minimum 95% task acceptance rate on Prolific.co. They were instructed to engage with the system through a structured process that included an introductory overview, interaction with a demo via case studies, and completion of a usability survey. 50 participants were recruited. They took an average of 23 minutes 48 seconds to read through the case studies and answer our survey.

The survey's questions, inspired by the Unified Theory of Acceptance and Use of Technology (UTAUT), aimed to evaluate the system's efficacy in enhancing article comprehension, detecting misinformation, and identifying logical fallacies. These questions were categorized into Performance, User Interface (UI), Language Learning Models (LLM), and Usability, as detailed below:
Performance: This category evaluates the system's influence on users' article understanding, misinformation detection capabilities, detection speed, reading effectiveness, credibility assessments, and grasp of logical fallacies. This aligns with DO1: Identifying potential fallacies in online news automatically.
UI: Questions in this section assess the utility of visual aids—like sentence underlining, dynamic links between article contents and fallacy tags, background color alterations, and pop-up explanations—in identifying fallacies. This aligns with DO2: Annotating detected fallacies (and other relevant information) dynamically.
LLM: Here, the focus is on user experiences with language learning models (e.g., GPT), specifically the trustworthiness of fallacy detection outcomes and explanations, along with the effects of real-time interactions.
Usability: This segment examines the ease-of-use of the framework, learning curve, clarity of interactions, annotation recognizability, information readability in pop-ups, ease of accessing desired information through GPT interactions, and overall contentment with the system's integration into the article reading workflow. Usability aligns with DO2 and DO3: Providing interventions to effectively reduce the fallacy influence

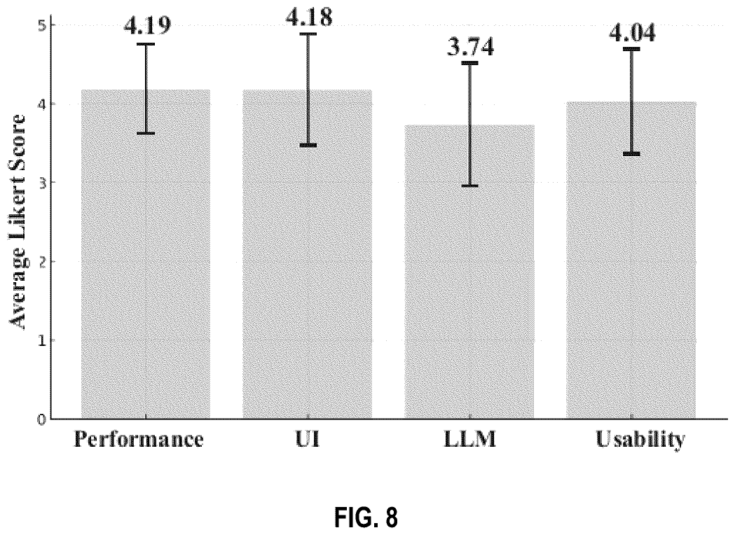

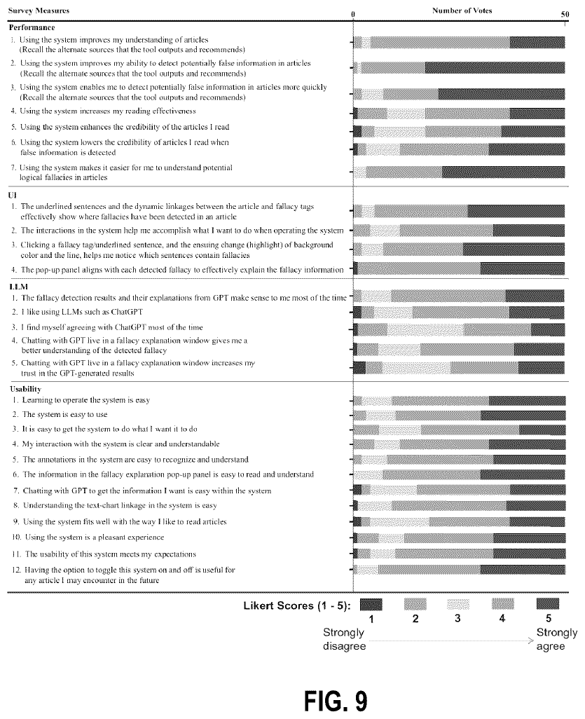

Overall, the quantitative analysis, FIG. 8, reveals a preference for the system's UI and usability components, with mean scores surpassing 4. The LLM category, while still positively received, yielded a marginally lower average score of about 3.74. Standard deviations across all categories show moderate response variability. The full survey measures and results are described herein and shown in FIG. 9.

### 6.2 Expert Interviews

Our methodology also incorporated feedback from a panel of experts (E1-E5) to assess the efficacy of our tool. E1, with expertise in computing and misinformation studies, alongside E2-E5, subject matter experts in communications, provided feedback into the tool's design and functionality. We conducted semi-structured interviews, allowing each expert approximately 30 minutes to engage with the tool and examine three case studies presented in Section 5. This was followed by a series of questions aligned with the design objectives outlined in Section 3.1. The interviews were recorded, and transcriptions were later analyzed. Some experts also submitted written feedback as well. We detail the assessment by each expert of our tool's alignment with the design objectives, acknowledging its imperfections. For every objective, we discuss accompanying qualified concerns or limitations. These limitations and potential future work are further discussed in Section 7.
DO1: Identifying potential fallacies in online news automatically. Feedback on the tool's ability to automatically identify fallacies was predominantly positive. For instance, E2 highlighted its effectiveness in detecting subtle fallacies, stating, “It caught some things that I don't necessarily think I would have caught,” and affirming, “it helped me identify them more than I probably would have.” Similarly, E3 appreciated its specificity in identifying logical fallacies, which helps in pinpointing reasoning flaws: “I like that it identifies logical fallacies specifically it helps to identify, you know, the problem in the reasoning rather than just arguing that the facts of the matter.” However, E4 raised concerns about the tool's domain-specific effectiveness:” Just because I might be an so-called expert on misinformation, I mostly study Chinese propaganda. I don't know much about misinformation surrounding the Iowa caucus or climate change.” This feedback suggests that while the tool is effective in identifying fallacies, its performance may vary across different subjects, especially without the input of someone with specialized knowledge in those areas.
DO2: Annotating detected fallacies (and other relevant information) dynamically. The dynamic annotation feature received support for its potential to encourage readers to examine articles critically. E3 commended the tool for visual indicators of fallacies: “I like how it has the, you know, the underlining, and then you can top up this way. There is you can see the flags kind of fallacies that are like an article.” E4 praised its capacity to alert readers to misleading elements: “Your tool catches them and can give reminders to the reader like a ‘hey watch out for this little trick’.” Both of these comments support our objective of annotating the fallacies along with helpful information.
DO3: Providing interventions to effectively reduce the fallacy influence. Experts noted the tool's effective use of context and counterarguments to mitigate fallacy influence. E2 provided feedback on the tool's strategy for delivering context and counterargument: “it really, in my mind, did a good job of . . . discrediting the arguments.” Additionally, E2 praised the feature that encourages exploration of outbound links for further information, remarking, “those outbound links . . . were meant to be similar to, you know, someone opening up a . . . tab for, you know, alternate sources and information.” This feature aligns with our objective to promote lateral reading practices, which diminishes the persuasiveness of misinformation. Conversely, E4 raised a caution about the potential for backlash from fact-checking efforts, noting, “Fact-checking can also lead to backlash. There's a lot of literature on this.” This comment brings to light concerns regarding the reception of credibility systems by the public. E2 also commented on this concern, and this topic will be further discussed in Section 7.
DO4: Adapting to varying fallacy types. The primary focus of this design objective is detailed in Section 3.3. Nonetheless, E1 offered insights beyond merely adapting to various fallacy types, suggesting the tool's flexibility for integrating different components or utilizing alternative frameworks. E1 noted, “And this system is pretty flexible, which means we can connect to any, any, you know, large language models through the API.” Furthermore, they added, “we can, you know, set different parameters and temperatures for the job and say like, if you change the temperature, you should get some consistency in there.” These remarks, although not explicitly addressing the tool's adaptability to varying fallacies, suggest an underlying versatility in the design that paves the way for future enhancements and integrations.
DO5: Adapting to real-world scenarios. E2's overall positive outlook on the tool's real-world applicability supports DO5: “I think it would definitely help them come to a conclusion about the biases and fallacies that are being used to mislead them.” Similarly, E4 comments, “Your tool clearly increases fact-checking's capabilities . . . it is something that will help with accountability, transparency, and provides an educational tool.” Thus, both E2 and E4 agree that our tool supports DO5. However, E4 also advises caution regarding its application in complex real-world situations, reflecting on the complex dynamics of misinformation and belief systems: “I do think there should be people like you guys trying to help. I just want to offer a bit of caution because fact-checking like this is known to create backlash and even worsen political polarization adding fuel to the fire.” They suggest, “Maybe an idea would be to make a notice on your tool that still tells the reader they are free to make their own opinions about what they are reading, but that the intent of this tool is to provide background/context.” E4's comment about respect reader autonomy is important and will be discussed in Section 7.

### 7 Non-Limiting Conclusions/Observations

A novel framework is presented and aimed at enhancing the credibility of journalism by mitigating potential misinformation through the integration of LLMs and heuristic analysis. By developing a web browser extension that annotates and analyzes online data-driven news articles for fallacies and inconsistencies between text and accompanying data visualizations, we offer a comprehensive tool that aids readers in critically evaluating news content. Our research, supported by case studies, a crowdsourced study, and expert interviews, demonstrates the framework's effectiveness in identifying and annotating misleading information, thereby contributing to the reduction of misinformation spread. In this section, we gather insights and feedback from both our expert interviews, which confirm the effectiveness of our framework in a real-world context, while also identifying limitations and future work.

### Future Work (Contemplated and Incorporated Herein) (7.2)

Domain Adaptability: Following feedback from E1, a future research direction is to enhance domain adaptability by fine-tuning our tool and applying few-shot learning. This approach will enable and improve annotation usefulness in niche areas by gathering specific training data for these topics and employing few-shot learning to ensure robust performance. Similarly, another potential future research direction is to refine the model's overall performance through the optimization of the API, adjustment of the LLM temperature, and hyperparameter tuning. By adjusting the LLM temperature, the model's output variance can be managed, thereby enhancing the accuracy and relevance of its annotations. Additionally, as highlighted in Section 3.3, another straightforward future work involves expanding the classification of fallacies, enhancing our tool's ability to identify fallacies that were not covered in this current version.

Inocluation: E2 highlighted the potential of this approach to act as a beneficial agent for “inoculation,” a concept from communications theory described by Pfau and Burgoon. Inoculation is a psychological process that enhances an individual's resilience against persuasive attempts through early exposure to weakened counterarguments, thereby preparing them to effectively counter such challenges. This process begins by presenting a manageable threat to an individual's beliefs or attitudes to stimulate their defenses. Subsequently, individuals receive counterarguments to potential attacks, accompanied by strategies for rebuttal. This approach familiarizes individuals with potentially challenging arguments and teaches them how to counter these arguments. The benefits of inoculation are resistance to persuasion, enhanced critical thinking, preparation for future attacks, all of which can serve as another framework for detecting potential misinformation. Whereas previous work focus on fact-checking and our work focuses on fallacies, a future work along this vein can focus on inoculation, which requires elements of inoculation theory to be strategically placed inside the framework.

Personalized Approach with Cognitive Biases: E5 suggested that a personalized approach to mitigating misinformation is helpful, pointing out the cognitive biases codex, which categorizes 188 cognitive biases as a foundation for its detection framework. These biases each represent a pattern of deviation from rationality in judgement, and vary from each person to person. The study on the cognitive biases codex underscores the importance of cognitive bias detection in addressing misinformation and enhancing decision-making processes. The authors suggest that the ability to automatically detect and measure cognitive biases could significantly advance our understanding of human cognition and improve information quality across digital platforms, and thus it can offer a more targeted and effective way to help readers pinpoint and correct misinformation.

### APPENDIX A (LLM PROMPTS)

### A. 1 Prompt for Detecting Logical Fallacies

Here are 10 fallacies:
Evading the Burden of Proof (EBP): This fallacy occurs when someone makes a claim but refuses to provide evidence to support it, shifting the burden of proof to others. Example: A politician claims that a new policy will improve the economy but does not provide any data or reasoning to support this claim.
Strawman (ST): Misrepresenting someone's argument to make it easier to refute than the original argument. Example: Person A says we should have stricter gun control. Person B responds by saying Person A wants to take away all guns, which is a distortion of the original argument.
False Authority (FAUT): This fallacy is citing an authority on a topic who is not actually an expert in that field. Example: A celebrity endorses a specific drug for heart health, despite having no medical expertise.
Red Herring (RH): Diverting attention from the real issue by introducing an irrelevant topic. Example: During a debate on environmental policies, a politician digresses to the opponent's personal life instead of addressing the policy issue.
Cherry Picking (CP): Selectively presenting evidence that supports one's argument while ignoring evidence that contradicts it. Example: A report on climate change highlights only data supporting global warming, ignoring data that suggests otherwise.
False Analogy (FA): Making a misleading comparison between two things that are not truly comparable. Example: Comparing the job of a teacher to that of a babysitter, implying they require similar skills and should therefore be compensated similarly.
Hasty Generalization (HG): Making a generalized statement based on a small or unrepresentative sample. Example: Meeting three aggressive dogs and concluding that all dogs are aggressive.
Post Hoc (PH): If because one event followed another, the first event caused the second. Example: Believing that carrying a lucky charm resulted in winning a game, just because the win came after starting to carry the charm.
False Cause (FC): Mistaking correlation for causation, if because two events occur together, one causes the other. Example: Asserting that ice cream consumption causes drowning because both increase during the summer.
Vagueness (VAG): Using imprecise, unclear, or ambiguous language in an argument. Example: A politician says they will “make the economy better” without specifying any actual policies or steps.

Here are additional fallacies if using a data visualization:
Setting an Arbitrary Threshold (SAT): This fallacy occurs when an arbitrary standard is set to judge a phenomenon, without considering the broader context or implications. Example: Claiming that COVID-19 is not a significant concern because “only” 1 in 23 deaths were caused by it, ignoring the overall impact and spread of the disease.
Issues with Data Validity (IDV): This fallacy arises when there are concerns about the accuracy and consistency of data, which are either exaggerated or ignored to support a preconceived notion. Example: Arguing that the number of COVID-19 cases is inflated due to miscounted influenza cases, despite lacking substantial evidence to support this claim.
Failure to Account for Statistical Nuance (FASN): This occurs when crucial statistical details are overlooked or simplified in an argument, leading to misleading conclusions. Example: Concluding that vaccines are ineffective based on the number of infections in a vaccinated population, without comparing it to infection rates in an unvaccinated control group.
Misrepresentation of Scientific Studies (MOSS): This involves exaggerating the significance of certain scientific findings that align with one's beliefs or outright rejecting scientific authority in favor of personal anecdotes or pseudo-science. Example: Discrediting the efficacy of vaccines by selectively citing studies that show a small number of breakthrough cases, while ignoring the overwhelming evidence of their effectiveness.

Please state all logical fallacies that are present in the text from this list. Explain where the fallacy occurs and why. Sometimes, the text will reference a data visualization. Either I will provide the data visualization, or I will give you the specifications and the data. You may assume that if there is no data visualization, the fallacies are limited to the first ten provided in the list.

```
  Output a JSON (example):
{cases: [{
“name”: “Title”.
“source”: “WSJ”,
“sentences”: {1: “sentence 1”,2: “sentence 2”}
“fallacies”: {
  “logical_fallacies”: [“CP”, “RH”],
  “sentences”: {
    “CP”: [4, 5, 10],
    “RH”: [17, 18]},
  “annotations”: {
    “CP”: {
      “L1”:[{
        “explanation”: “insert explanation here”,
        “sentence”: [4,5],
        “link”: “URL”}],
      “L2”: [{
      “explanation”: “insert explanation here”,
        “sentence”: [4,5]}],
      “L3”: [{
        “explanation”: “”,
        “sentence”: [4,5]}]
    }
  }
}}]}
```

Level 1 (L1) focuses on immediate correction, Level 2 (L2) provides a detailed analysis with evidence, and Level 3 (L3) aims to preemptively inform and educate the reader about potential misinformation. All explanations should be filled.

Each explanation should: Be supported by specific examples and evidence from reputable sources. Incorporate at least one outbound link to Google or Bing that offers a contrasting viewpoint or additional data if appropriate. Please only use Google or Bing, replacing the query with the contrasting idea. For example, if you suggest looking at examples where “the earth is not flat” then provide the link https://www.google.com/search?q=the+earth+is+not+flat Output in JSON code environment.

### A. 2 Prompt for Chart-Text Linkage

A data visualization will be defined for you. The dataset will be provided in a univariate x,y CSV format. I define 7 fallacies here that can be related to the data visualization:
Cherry-Picking: Selecting data that supports a conclusion while ignoring data that contradicts it. Example: Using a single data point to argue against COVID-19 measures without considering broader data.
Setting an Arbitrary Threshold: Judging phenomena based on a subjective or baseless standard. Example: Declaring COVID-19 not a concern because “only” a specific small percentage of deaths are attributed to it, without considering the overall impact.
Causal Inference: Incorrectly attributing cause and effect based on limited or anecdotal evidence. Example: Suggesting a spike in cases is caused by vaccine distribution without considering other factors.
Issues with Data Validity: Questioning the accuracy and consistency of data to support a preconceived notion. Example: Arguing the number of COVID-19 cases is overreported without substantial evidence.
Failure to Account for Statistical Nuance: Overlooking important statistical details that lead to misleading conclusions. Example: Concluding vaccines are ineffective by showing infections in a vaccinated population without comparing it to an unvaccinated control group.
Misrepresentation of Scientific Studies: Exaggerating or misinterpreting scientific findings to confirm personal beliefs. Example: Promoting the efficacy of a drug based on unreviewed or disproven studies.
Incorrect Reading of Chart: Misinterpreting visual data due to visual distortions or incorrect assumptions. Example: Misreading a chart comparing COVID-19 cases in different regions due to inconsistent data granularity.

Finally, a news article will be supplied, with sentences numerically indexed starting from 1. Split the sentences and include them in the output. Based on your interpretation of the chart, identify sentences within the article that reference the chart's data and provide an annotation for each. When such a reference is identified, indicate the approximate location by using the independent variable x. When a fallacy is detected that relates to the visualization, please note indicate the approximate range of locations “x” and which sentence it appears in the text by number.

Start each annotation with the reason why there is a logical fallacy.

Output a JSON (example):

```
{
“reference_sentences”: [“1-2”]
“ranges”: [“1990-1995”],
“annotations”: [{
  “fallacy”: :Misrepresentation of Scientific Studies”,
    “reason”: “”,
    “explanation_levels”: {
      “L1”:””,
        “L2”:””,
      “L3”: “”
    }
}]}
```

“sentences” Key: This key maps to an object where each property is a sentence number from the original article text, with its corresponding sentence as the value. It serves as a straightforward enumeration of sentences for easy reference.

“reference_sentences” Key: This array contains strings indicating which sentences from the article contain references to data visualizations. The numbers correspond to the sentence numbers in the “sentences” object. A hyphenated pair (e.g., “1-2”) signifies that the reference spans both sentences, while a single number (e.g., “5”) indicates a reference contained within a single sentence.

“ranges” Key: This array should contain strings representing specific, focused x-values in the data that are directly referenced in the visualization.

To ensure accuracy and relevance, follow these guidelines: Only include ranges that correspond to specific, notable changes or features in the data as presented by the visualization. For instance, if the visualization shows a significant trend change, peak, or trough at certain periods, those periods should be the ones included in the “ranges”.

Avoid using broad, all-encompassing ranges that cover the entire dataset. Instead, focus on narrower time spans or data points that are directly discussed or highlighted within the article or the visualization commentary.

Each range should be directly relevant to the points of discussion or analysis in the annotations. If an annotation discusses a particular trend, event, or comparison within a specific time frame, the range should precisely match this time frame.

If the dataset or visualization covers a long time span, break down the range into smaller intervals that correspond to different phases or segments of the data being discussed. This approach allows for a more detailed and accurate correlation between the textual references and the data visualizations.

Ensure that the selected ranges are meaningful within the context of the data visualization. For example, if discussing a particular trend's impact or a comparison between two time periods, choose ranges that effectively capture the following elements without extending beyond the necessary scope:
“annotations” Key: This array contains notes that explain the relationship between the article's text (as specified in “reference_sentences”) and the information depicted in charts or data referenced within the article. Each annotation offers insight or critique on how the article text correlates with, or misinterprets, the chart data. Within each annotation, there are three levels as defined:
L1 (Level 1) offers an immediate correction or clarification to rectify the misunderstanding or misinterpretation directly.
L2 (Level 2) delves deeper, providing a detailed analysis with evidence to support the correction, including examples, comparisons, or links to external reputable sources for further reading.
L3 (Level 3) aims to educate the reader about the broader context, helping to preempt future misunderstandings by suggesting resources, methodologies, or critical thinking approaches related to the topic.

Additional aspects of this disclosure are set out in the independent claims and preferred features are set out in the dependent claims. Features of one aspect may be applied to each aspect alone or in combination with other aspects. In addition, while certain operations in the claims are provided in a particular order, it is appreciated that such order is not required unless the context otherwise indicates.

What is claimed is:

1. A computer-implemented method for detecting and presenting fallacies in digital media, the method comprising:
accessing, by one or more processors, input digital media;
extracting textual content elements and chart image elements from the input digital media;
structuring the extracted textual content elements and chart image elements into a machine-readable representation in accordance with a predefined schema comprising (i) article text spans, (ii) chart data series, and (iii) bounding-box metadata;
executing, by a large language model (LLM) operating under deterministic decoding constraints, one or more stored prompt templates on the machine-readable representation to generate:
(i) a classification of whether a logical or visual fallacy is present in the input digital media,
(ii) a linkage between a particular textual content span and a corresponding chart data series or bounding box, and
(iii) a justification string describing the detected fallacy; and
generating, in response to execution of the stored prompt templates, a structured machine-readable output, in accordance with the predefined schema, that categorizes:
(i) logical fallacies detected in the textual content elements, each fallacy entry including a classification and a justification string, and
(ii) chart-text linkages associating sentence ranges in the textual content elements with corresponding chart data series or bounding boxes.

2. The method of claim 1, wherein the structured machine-readable output is serialized as a JavaScript Object Notation (JSON) document.

3. The method of claim 1, wherein the structured machine-readable output comprises an array of logical fallacies detected, with each array element including a classification of a fallacy type and a rationale for the detected fallacy.

4. The method of claim 1, wherein the structured machine-readable output further comprises sentence ranges indicating where each fallacy occurs within the textual content.

5. The method of claim 1, wherein the structured machine-readable output further comprises data identifying sentences in the textual content and their corresponding areas within the chart.

6. The method of claim 5, wherein the corresponding areas within the chart are defined by bounding-box coordinates derived from the chart image elements.

7. The method of claim 1, wherein the structured machine-readable output further comprises annotations that provide explanatory notes linking the detected fallacies with the corresponding sentence ranges and chart areas.

8. The method of claim 1, wherein the structured machine-readable output further comprises metadata identifying a schema version associated with the output.

9. The method of claim 1, further comprising validating the structured machine-readable output against the predefined schema by performing at least one deterministic post-processing operation selected from the group consisting of schema-constrained parsing, regular expression validation, and multi-pass consensus voting.

10. The method of claim 9, wherein validating further comprises checking that each sentence range corresponds to an existing sentence in the textual content and that each chart area falls within the boundaries of the chart image element.

11. A method for combating misinformation in digital media, comprising:
accessing, by a processor, input digital media including textual content and at least one chart;
executing, by a large language model (LLM), a set of stored prompt templates including at least:
(i) a first prompt configured to detect logical fallacies in the textual content by analyzing argument structure and logical soundness across the media, and
(ii) a second prompt configured to identify linkages between the textual content and the chart; and
generating, in response to execution of the stored prompt templates, a structured machine-readable output that categorizes:
(i) logical fallacies detected in the textual content, each including a classification and a rationale, and
(ii) chart-text linkages associating portions of the textual content with corresponding areas of the chart.

12. The method of claim 11, wherein the structured machine-readable output further comprises sentence ranges indicating where each logical fallacy occurs within the textual content.

13. The method of claim 11, wherein the structured machine-readable output further comprises data associating individual sentences of the textual content with bounding-box coordinates that define corresponding areas within the chart.

14. The method of claim 11, wherein the structured machine-readable output further comprises annotations that provide explanatory notes linking each detected logical fallacy with the corresponding sentence ranges and chart areas.

15. The method of claim 11, wherein the structured machine-readable output further comprises metadata including a schema version identifier associated with the output.

16. A non-transitory computer-readable medium storing instructions that, when executed by one or more processors, cause the processors to:
generate input for at least one large language model (LLM), by:
(i) extracting text information from digital content, and
(ii) extracting data and metadata from data visualizations in the digital content;
execute, by the LLM, a set of stored prompt templates including at least a first prompt configured to detect logical fallacies in the textual content by analyzing argument structure and logical soundness, and a second prompt configured to identify linkages between the textual content and the data visualizations; and
generate, in response to execution of the stored prompt templates, a structured machine-readable output categorizing (i) logical fallacies detected in the textual content, each including a classification and a rationale, (ii) sentence ranges indicating locations of the detected fallacies, and (iii) chart-text linkages associating one or more of the sentence ranges with corresponding areas of the data visualizations.

17. The non-transitory computer-readable medium of claim 16, wherein the instructions improve computer functionality by producing a structured machine-readable output that enforces a schema defining arrays of fallacies, sentence ranges, and chart-text linkages, thereby reducing variability and increasing reliability of large language model outputs.

18. The non-transitory computer-readable medium of claim 16, wherein the instructions improve digital media analysis by correlating textual sentence ranges with corresponding chart areas, thereby enabling automated verification of consistency between narrative statements and quantitative data representations.

19. The non-transitory computer-readable medium of claim 16, wherein the instructions improve upon traditional fact-checking by causing the processors to detect logical and reasoning errors within arguments that are composed of factually accurate statements, thereby enabling identification of misinformation that conventional fact-checking fails to expose.

20. The non-transitory computer-readable medium of claim 16, wherein the instructions enhance the operation of large language models by constraining outputs to conform to a predefined schema and validating the outputs deterministically, thereby reducing hallucinations and increasing accuracy in automated misinformation detection.
